(19) United States
(12) Patent Application Publication
(10) Pub. No.: US 2013/0259377 A1
(43) Pub. Date: Oct. 3, 2013

(54) CONVERSION OF A DOCUMENT OF CAPTURED IMAGES INTO A FORMAT FOR OPTIMIZED DISPLAY ON A MOBILE DEVICE

(71) Applicant: NUANCE COMMUNICATIONS, INC., Burlington, MA (US)

(72) Inventor: Herr Cüneyt Göktekin, Potsdam (DE)

(73) Assignee: Nuance Communications, Inc., Burlington, MA (US)

(21) Appl. No.: 13/852,937

(22) Filed: Mar. 28, 2013

(30) Foreign Application Priority Data
Mar. 30, 2012 (DE) 102012102797.8

(51) Int. Cl. G06T 3/00

(52) U.S. Cl. CPC G06T 3/0056
USPC 382/176

(57) ABSTRACT

Systems may be provided for recording a document with a camera-based mobile radio device and for converting textual information in the document into a format for suitable presentation on the mobile device. A document may be recorded by the mobile device in an image. A layout structure may be recognized with a text block in the image. Character text in the text block may be recognized by OCR. An order of the text blocks may be determined by taking into account the layout structure. A suitable format for presenting the character texts on the mobile device's display may be selected. The format may be adapted to a width of the display so that during reading of the character texts on the display, substantially only vertical scrolling is necessary. A file may be generated and displayed in the format with the character texts in the determined order of the text blocks.

### RELATED APPLICATION

This application claims priority under 35 U.S.C. §119 or 365 to German Patent Application No. 102012102797.8, filed Mar. 30, 2012. The above referenced application is incorporated by reference in its entirety.

### BACKGROUND

Currently, mobile radio devices, such as a mobile phone, smartphone, a tablet computer, or the like, mostly have integrated cameras with a resolution of five to twelve megapixels. The mobile radio devices are constant companions of their users, and business people, above all, therefore desire a constant expansion of possibilities of usage. Frequently, the camera-based mobile radio devices are also used for taking notes of a newspaper article or a document by means of the camera or for translation purposes.

### SUMMARY OF THE INVENTION

Existing methods and systems are not adapted for adequately displaying the document, which has for instance been recorded via several subsequent images, on a small display of a mobile radio device. During reading of a document, scrolling to the side is generally required as well, rendering the reading of a wide-format newspaper very tedious for the user.

Generally, no satisfactory representation of text documents recorded by the mobile radio device on the mobile device itself is available without the necessity of scrolling, for instance, laterally.

Some embodiments of the present invention may include a method and a device for recording a document with a camera-based mobile radio device and for converting the document with the textual and image information contained therein into a format which is adapted for a display of the mobile radio device, especially in width.

Some embodiments of the invention can provide a method and a device for recording a document by means of a mobile radio device with integrated camera and for converting textual information of the captured document images into a format which is adapted in width to a display of the mobile radio device so as to save the user lateral scrolling during reading. Thereby the correct order of text is to be recognized and maintained.

The above may be achieved by a method and a device for recording and converting a document by a camera-based mobile radio device according to the independent claims. Further embodiments of the invention are indicated in the dependent claims.

Useful features include the possibility of simply recording documents by a mobile radio device, page by page or text block by text block, and then automatically converting the texts so that subsequent text blocks are arranged below one another and displayed on the mobile radio device in the correct order. Accordingly, in case of subsequent text blocks arranged adjacent to each other, scrolling would not have to take place laterally but only vertically; lateral scrolling would be very tedious on mobile radio devices for a user. Subsequent text blocks of a document are recognized and re-arranged in the correct order by being brought into a suitable layout or format which is just wide enough to correspond to the display of a mobile radio device. The text blocks are stored as a file in accordance with the suitable format and are thus available in a conveniently readable form on the mobile radio device as a text document. Especially in cases of wide-format documents, such as in newspapers, or with documents in the landscape format, this kind of conversion is very convenient since a continuous text is displayed on the mobile radio device which is automatically adapted to the width of the display and wherein scrolling only has to take place vertically along the text and not laterally.

Two advantageous methods are illustrated. With one method, the images are converted in the mobile radio device in their entirety; with the other method, the images are converted, for the larger part, on a server so as to save computing power and save a copy in a document archive.

In addition, documents can be stored in an additional second form adapted, for instance, for PC monitors. Thus, also the textual content of newspapers that are far wider than DIN A4 can be adapted to a DIN A4 width and stored. Such an optimized representation allows the user to conveniently read a photographed document text without the necessity of a lengthy search wherein a current text passage is continued.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1a shows an image of a document with different text blocks, article headings and two pictures.

FIG. 1b shows another image of a document with different text blocks, article headings and three pictures.

FIG. 2 shows on the left a first part of a file in a format suitable for being displayed on a mobile radio device with the text blocks from FIG. 1a, wherein the right part of the image showing a second part of the file continuing the first part.

FIG. 3 shows the same document with the different text blocks from FIG. 1a, wherein the different text blocks are captured as three images by a camera-based mobile radio device.

### DETAILED DESCRIPTION

A description of example embodiments of the invention follows.

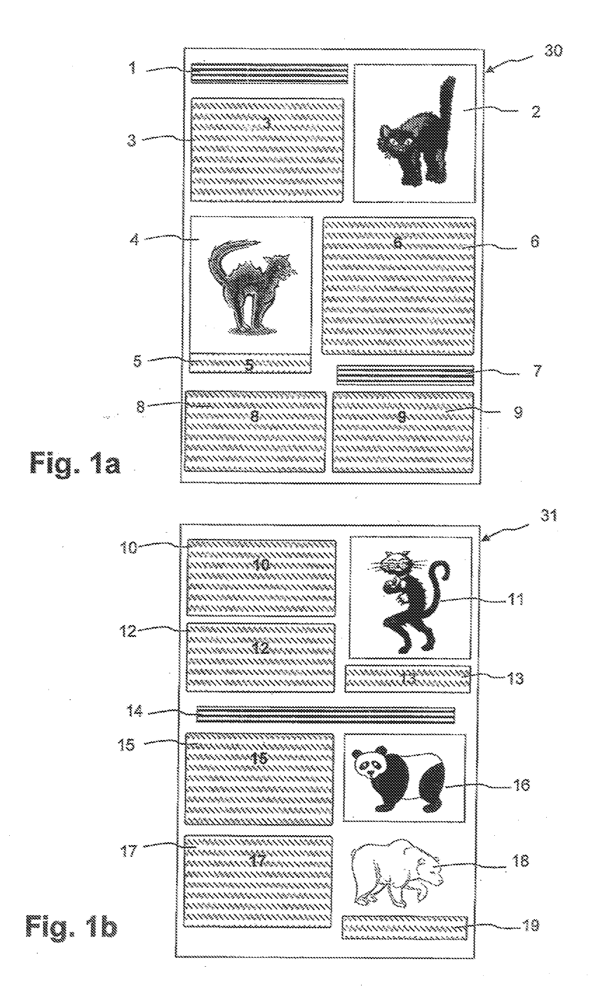

FIG. 1a represents a first page and FIG. 1b a second page of an exemplary document. The first page of the document shows, for example, a first heading in position 1 of a first article with corresponding text blocks in positions 3, 5, 6 and pictures in positions 2, 4 and a second heading in position 7 of a second article with corresponding text blocks in positions 8, 9. On the second page, in FIG. 1b, the second article is continued by corresponding further text blocks in positions 10, 12, 13 and by a picture in position 11. On the second page there follows also a third article with a third heading in position 14, with corresponding text blocks in positions 15, 17, 19 and two pictures in positions 16, 18.

For recording the document shown in FIGS. 1a and 1b, putting it into an archive and making it readable on a mobile radio device, the first and second pages are preferably photographed by means of the mobile radio device, wherein in this example a first image 30 and a second image 31 being stored by the camera of the mobile radio device. In the example shown, the first image 30 comprises a first image area and the second image 32 comprises a second image area. In the case of documents with a plurality of pages, all pages to be put into the archive are photographed accordingly. It is also conceivable to provide recognition of an appropriate adjustment of the camera in relation to the text to be recorded by the mobile radio device. During this process, it is also possible to employ acoustic feed-back methods for appropriate adjustment.

Preferably, the first image 30 is processed by a layout recognition system so that in the first image 30 the text blocks in positions 1, 3, 5, 6, 7, 8, 9 and preferably the pictures in positions 2, 4 are recognized. During this process, a layout structure, i. e. a distribution of the text blocks and preferably of the pictures in the first image 30, is recognized and stored. The layout structure is then evaluated for determining which contiguous text blocks and pictures belong to one article and which to another article. The layout recognition method is based on well-known method for digital image processing, for preferably recognizing edges and text blocks, i.e., parts with text. Also, preferably pictures can be recognized. Preferably, the layout recognition system also recognizes spaces between the text blocks and pictures. Furthermore, the layout recognition system preferably recognizes headings in a text block, i. e. whether a specific text block is a heading, such as in positions 1 and 7 in FIG. 1a. For recognizing a heading, the layout recognition system can either determine the font size in comparison to the font size of neighboring text blocks or it can, for instance, take syntactic characteristics into account. For this purpose, output parameters of a subsequent OCR analysis can be used as well. The second image 31 and additional images, if available, are processed in the same way as the first image 30.

The recognized text blocks are entered in an Optical Character Recognition (OCR) system which recognizes and outputs character text therein. Alternatively, the entire first image 30 can be entered in the OCR system. The character text(s) is/are preferably stored in a standard text format or as running text and associated with the respective text block. Hyphens for wordwrap are preferably removed. It is also conceivable to use additional digital preprocessing method for image improvement so as to allow a better recognition of the character text. The second image 31 and, if applicable, additional images are processed in the same way as the first image 30.

In a subsequent step, an order recognition system determines an order of the previously determined text blocks and preferably also of the pictures. The order recognition system preferably takes into account the following parameters, subfunctions and sub-method:
a spacing of the text blocks from each other;
a syntactic linking, if for instance a last sentence in a text block is continued and finished in a next text block;
an arrangement rule which is recognized, such as top left—bottom left, top right—bottom right;
hyphens and/or frames around text blocks;
continuation of hyphens and/or frames around text blocks in neighboring images;
recognition and analysis of at least one keyword in contiguous text blocks;
recognition of successive texts with neural networks.

For order recognition, preferably numerous method working in parallel are used which recognize the order of the text blocks and preferably of the pictures. Semantic recognition method can be employed as well. Also, preferably a word histogram analysis of the respective character texts of the text blocks is performed which allows allocation to a specific article in the document. Also conceivable is an additional employment of an edge filter with subsequent cluster determination for recognizing the text blocks in this manner. Also, preferably successive images 30, 31 are examined for a continuity and order of text blocks. The respective order of the text blocks is stored and can be applied to the character texts associated with the text blocks.

Then a suitable format is defined for storing the character texts and preferably the pictures. The suitable format is determined such that a width of the character texts contained therein, i. e. the line width, and preferably an additional width of the pictures do not exceed the width of a display of the mobile radio device, in other words, the width of the suitable format is determined such that the line width corresponds exactly to the width of the display. Furthermore, the suitable format has a font type and font size by means of which the character texts are displayed and easily readable for the user. Preferably, the user can set the desired font type and font size, such as Arial 10, Times 11 or the like. Now the character texts are saved in the order previously determined and in the suitable format, wherein the appropriate wordwraps and preferably the hyphenations get inserted. If pictures have been recognized in the layout structure and saved, these pictures are preferably also saved at the appropriate positions between the character texts in the correct order. The suitable format is either a fixed format stored in a memory or a variable format which takes into account parameters which are either entered by the user or can be retrieved from the mobile radio device, such as the desired font size and font type on the display.

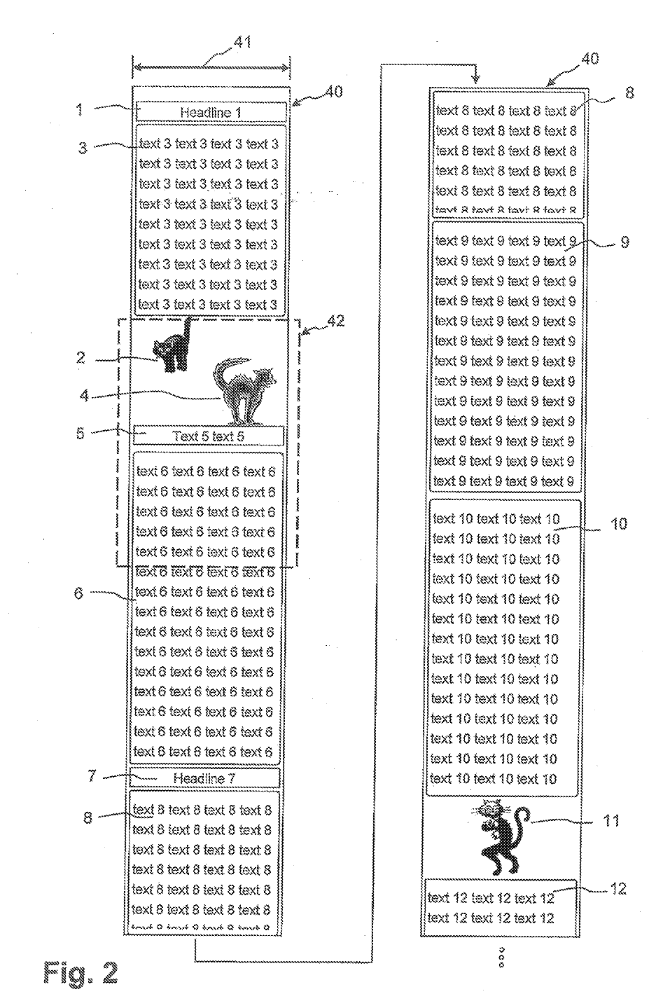

FIG. 2 shows a presentation of a file 40 comprising character texts and pictures which were stored in the suitable format in the specific order. The recognized first heading in position 1 of the first image 30 in FIG. 1a was saved at the very top in position 1 of the file 40. The heading in position 1 is followed in position 3 of the file 40 by the character text, originated from the text block in position 3 of the first image 30. It is followed by picture 2 and then picture 4 in the file 40 in the same order as they were recognized in the first image 30. The character text in position 5 is followed by the character text in position 6 of the file 40. A second length of the character text in position 6 of the file 40 is greater than a first length of the same character text of the text block in position 6 of the first image 30, which is due to the fact that the font size in file 40 is larger than in the corresponding text block in position 6 of the first image 30.

In position 7 of file 40, there is a new heading recognized in the text block in the first image 30 in position 7. It is followed by the character texts in positions 8, 9 and 10, the picture in position 11 in file 40 and additional character texts and pictures which are not represented in FIG. 2. The file 40 can have any length and comprises the character texts and preferably the pictures that were recognized in the captured images 30, 31 of the document.

The file 40 shows a width 41 of the format and, in dashed lines, a portion 42 of the file which is represented on the display of the mobile radio device. For the person skilled in the art, it is easily conceivable, when he/she regards FIG. 2, that for reading the document in the converted form described above in the suitable format, lateral scrolling is no longer necessary but that the user simply has to scroll up and down in order to read the continuous text.

The file 40 can be saved on the mobile radio device, wherein the file 40 is preferably a standard text file without pictures, such as an ASCII text file, or a PDF file preferably with pictures, a Microsoft® Word file or a file in another standard format. The file 40 can also be saved on a server if the previous processing steps have taken place on a server.

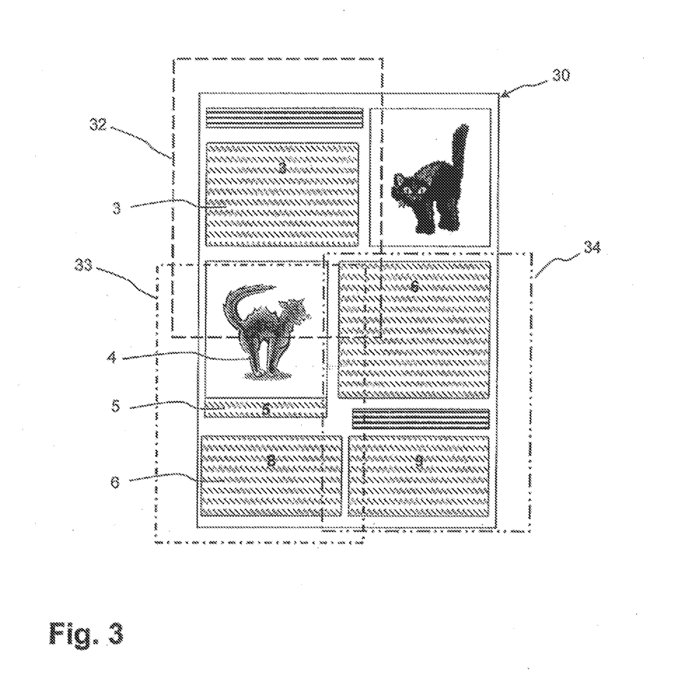

FIG. 3 shows that the first page of the document shown in FIG. 1a on a first image 30 can also be represented by three images, i. e. a third image 32, a fourth image 33 and a fifth image 34. By taking several pictures of a document page, a higher resolution of the text blocks contained therein can be achieved for each image. The higher resolution normally allows a higher OCR recognition rate, justifying the greater effort depending on document material and quality of the mobile radio camera. The example in FIG. 3 shows two text blocks and half a picture in position 4 in the third image 32. The subsequent fourth image 33 shows two text blocks and the picture in position 4.

This shows that the order recognition system conveniently also recognizes overlapping areas owned in common by two images. Thus, for instance, it can be seen in the third image 32 and in the fourth image 33 that the text block in position 3 of the third image 32 is followed by the picture in position 4 of the fourth image 33 and the picture in position 4 is followed by the text block in position 5 of the fourth image 33.

The order recognition preferably also comprises a system for recognizing and stitching neighboring images 32-34 so as to be able to better recognize neighboring and successive text blocks.

Furthermore, it is also conceivable that instead of having all processes performed on the mobile radio device, part of them is performed on an external server. Thus, it is conceivable that the captured images 30-31 or 32-34, respectively, e. g. the first image 30 and the second image 31 as well as other images 32-34 of the document, are transferred to a server by the mobile radio device.

The server processes the images 30-31 or 32-34, respectively, by recognition of the respective layout structures, performs an OCR recognition and an order recognition and generates the file 40 as described above. Then the server sends the file 40 back to the mobile radio device wherein the file 40, i. e. the document, can then be viewed on the mobile radio device in the suitable format. It is also conceivable to export other partial processes to the server, e. g. only the OCR conversion or the order recognition and the like.

One advantage of sending the images 30-31 or 32-34, respectively, to a server also includes in the fact that on the server, a file 40 can also be simultaneously generated in a second format, the second format being substantially suited for representation on a PC monitor or for printing on standardized printing paper. The second format has a second width which corresponds e. g. to a width of the DIN A4 format or the US letter format. It can also be determined, for instance, whether the second format is to be adapted to a portrait or a landscape format or have a different width. Preferably, also the font type and/or the font size can be adjusted.

Another method for converting the captured images 30-31 or 32-34, respectively, of the document into another suitable format is, firstly, to again recognize the layout structure and the order of the text blocks and preferably of the pictures. With this method, however, the text blocks and preferably the pictures are then stitched together as picture components in the other suitable format. This means that no OCR conversion of the textual information is performed but that simply the picture components of the text blocks and the pictures which are automatically cut digitally from the respective image are arranged in the determined order and composed to form a file 40.

Other possible embodiments are described in the following claims.

The reference numbers in the claims are for better comprehensibility, but do not limit the claims to the embodiments shown in the figures.

### LIST OF REFERENCE NUMBERS

1-19 position

30 first image

31 second image

32 third image

33 fourth image

34 fifth image

40 file

41 width of the format

42 section

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

For example, the present invention may be implemented in a variety of computer architectures.

The invention can take the form of an entirely hardware embodiment, an entirely software embodiment or an embodiment containing both hardware and software elements. In one preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Some examples of optical disks include compact disk—read only memory (CD-ROM), compact disk—read/write (CD-R/W) and DVD.

A data processing system (e.g. mobile phone, client system, server system, computer terminal, tablet, and the like) suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code are retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. Method for recording a document with a camera-based mobile radio device and for converting textual information of the document into a format for suitable representation on the mobile radio device, the method comprising:
a) recording the document by the mobile radio device to at least one image and saving the at least one image;
b) recognizing a respective layout structure with at least one text block in the respective image; and
c) recognizing character text in the respective text block by application of Optical Character Recognition (OCR) and saving the respective character text of the corresponding text block by:
d) determining and storing an order of the respective text blocks in the document, taking into account the respective layout structure;
e) selecting a suitable format for representing the character texts on a display of the mobile radio device, the suitable format being adapted to a width of the display so that only vertical scrolling has to take place during reading of the character texts on the display; and
f) generating a file in the suitable format with the respective character texts in the specific order of the respective text blocks, where the file is configured to automatically adapt the to the width of the display;
g) provisioning the file to the mobile radio device for presentation on the display such that it automatically adapts to the width of the display.

2. The method according to claim 1, wherein the suitable format is selected and adapted to a selectable character size and character type.

3. The method according to claim 1, wherein in b) in the layout structure also pictures are recognized, wherein in d) the pictures are included in the order of the text blocks so that an order of the text blocks and of the pictures is created and wherein in 0 the pictures are adapted to the width of the display so that only vertical scrolling has to take place during presentation on the mobile radio device.

4. The method according to claim 1, wherein the layout structure is recognized based on a histogram analysis of the black density distribution in the respective image.

5. The method according to claim 1 wherein in d) during determination of the order of the respective text blocks, the order of the text blocks placed below one another is taken into account, and a syntactic connection between text blocks placed next to each other is analyzed, wherein for instance text blocks placed next to each other complement each other syntactically and therefore succeed each other with high probability.

6. The method according to claim 1, wherein in d) during determination of the order of the respective text blocks, a semantic connection between neighboring text blocks is analyzed for determining whether they belong to the same or to a next topic.

7. The method according to claim 1, wherein in d) during determination of the order of the respective text blocks, for neighboring text blocks, a histogram word analysis or edge filtering with subsequent cluster determination is performed and taken into account for determining whether they belong to the same or to a next topic.

8. The method according to claim 7, wherein during histogram word analysis keywords, the keywords of a heading of a respective article of the document are used.

9. The method according to claim 8, wherein in d), during determination of the order of the respective text blocks, the sequence of the successive pictures is taken into account as well.

10. The method according to claim 1, wherein in d), during determination of the order of the respective text blocks, semantically associated text blocks of successive pictures are examined and taken into account as well.

11. The method according to claim 1, wherein in e) the selected suitable format is a PDF format with a width corresponding to the width of the display of the mobile radio device.

12. The method according to claim 1, wherein in e) the selected suitable format is a standard text format with a width corresponding to the width of the display of the mobile radio device.

13. The method according to claim 1 wherein the stored at least one image in a) is transferred to a server, wherein b-d) are executed in the server and the character texts and the suitable order of the respective text blocks are re-transmitted to the mobile radio device.

14. The method according to claim 1 wherein the respective character texts in the determined order of the respective text blocks are additionally saved in a second format, wherein the second format is an easily printable standard paper format which is easily usable on PC monitors for text reading for the DIN A4 format or the US letter format.

15. A server system for converting a text content from images which were captured by a mobile radio device from a document and transferred to the server system, the textual content being converted into a format suitable for presentation on the mobile radio device and being re-transmitted to the mobile radio device, the system comprising:
one or more processors configured to:
receive the images from the mobile radio device, the images containing at least one text block each;
recognize a respective layout structure with the at least one text block in the respective image;
recognize character text in the respective text block by application of Optical Character Recognition (OCR) and for saving the respective character text for the respective text block;
determine an order of the respective text blocks in the document, taking into account the respective layout structure;
select a suitable format for presenting the character texts on a display of the mobile radio device, wherein the suitable format is adapted to a width of the display so that during reading of the character texts on the display, only vertical scrolling is necessary;
generate a file in the suitable format with the respective character texts in the determined order of the respective text block;
send the generated file back to the mobile radio device.

16. The server according to claim 15, wherein the server is configured to recognize the layout structure based on a histogram analysis of the black density distribution in the respective image.

17. The server according to claim 15, wherein the server is configured to determine the order of the respective text blocks by performing, for neighboring text blocks, a histogram word process or edge filtering process with subsequent cluster determination, which includes determining whether the neighboring text blocks belong to a same topic or to a next topic.

18. The server according to claim 15, wherein during histogram word analysis keywords the keywords of a heading of a respective article of the document are used.

19. The server according to claim 15, wherein the server is configured to determine the order of the respective text blocks by determining semantically associated text blocks of successive pictures.

20. A data processing system for recording a document with a camera-based mobile radio device and for converting textual information of the document into a format for suitable representation on the mobile radio device, the system comprising:
a mobile radio device configured to:
record a document in at least one image;
store the at least one image;
recognize a respective layout structure with at least one text block in the respective image;
recognize character text in the respective text block by application of Optical Character Recognition (OCR) and save the respective character text of the corresponding text block;
determine and store an order of the respective text blocks in the document, taking into account the respective layout structure; and
a server, in communication with the mobile radio device, the server configured to:
select a suitable format for representing the character texts on a display of the mobile radio device, the suitable format being adapted to a width of the display so that only vertical scrolling has to take place during reading of the character texts on the display;
generate a file in the suitable format with the respective character texts in the specific order of the respective text blocks, where the file is configured to automatically adapt the to the width of the display; and
provision the file to the mobile radio device for presentation on the display such that it automatically adapts to the width of the display.
